(19) United States
(12) Patent Application Publication
(10) Pub. No.: US 2008/0052205 A1
(43) Pub. Date: Feb. 28, 2008

(54) System and method for identifying implicit events in a supply chain

(75) Inventors: Shawn Dolley, Arlington, VA (US); David George Shuman, Alexandria, VA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Vision Chain, Washington, DC (US)

(21) Appl. No.: 11/892,522

(22) Filed: Aug. 23, 2007

Related U.S. Application Data
(60) Provisional application No. 60/839,689, filed on Aug. 24, 2006.

(51) Int. Cl. G06Q 10/00

(52) U.S. Cl. 705/28

(57) ABSTRACT

The present invention is a method and system of identifying supply chain business scenarios using data from one or more Serialized Global Trade Identification Number (sGTIN) tag reads or other explicit supply chain data. Scenarios are asserted by calculating changes in data and comparing those with user definitions of scenario event combinations. A processor acquires the scenario definitions from a user defined metadata of products, locations, and measure variance criteria and correlates the sGTIN event reads and other events with this metadata to identify defined events that are not observed in the sGTIN event reads or other explicit data, or not observable by the tag readers. The system has a method for communicating these implicit events back to users.

### CROSS REFERENCE TO RELATED APPLICATIONS

This application claims benefit to the provisional application 60/839,689 filed on Aug. 24, 2006, which is incorporated by reference in its entirety herein.

### BACKGROUND OF THE INVENTION

1. Field of the Invention

The present invention relates generally to supply chain management.

2. Related Art

Radio Frequency Identification (RFID) technology is in wide use in the retail supply chain industry. RFID tag reads are typically filtered and associated with supply chain location and operational activities. Event reads within the supply chain are common at the palletizer, manufacturer shipping door, retailer receiving conveyor, the shipping conveyor, the receiving door, the backroom, between the backroom and sales floor, and the box crusher. This increased event granularity enables product to be tracked at numerous points through the supply chain, resulting in large volumes of data. Business users are now faced with a torrent of data (on average 10-12 event reads for every item/location/time combination) with the challenge to identify the events that are actionable and economically relevant. It is especially difficult to identify implicit events in a supply chain based on tag reads. Likewise, the majority of products in today's supply chains do not have RFID tags on them, or on their packing cases. As such, supply chain technology has evolved to record explicit events and statistics about items in the supply chain. This data is also voluminous, often incorrect, and hard to interpret. Limitations in technology maturity cause ubiquitous problems, even in the most advanced businesses. To wit, there is not a single variable measuring the quantity of product moving through any node of the supply chain that business stakeholders can believe with a high confidence level. This makes straightforward methods of monitoring and acting on this data incorrect or even disastrous.

The conventional approach to finding abnormally expensive events in the supply chain, errors, or other problems is to rely on data describing explicit events. For example, the retailer may take a count of estimated inventory, and determine that a retail store has zero inventory. That lack of inventory is a specific actual fact indicating a problem with the process the metric is defined to measure. While this may seem simple from a technical perspective, today's measuring systems are too often wrong or do not account for all possible outcomes or product locations, and as such it leaves the retailer, manufacturer, or supply chain user open to a myriad of problems. These include, first, that the data may be wrong. In the example here, if inventory is actually more than zero, although the simple explicit event indicates zero inventory, then product will be ordered to replenish the shelf, when none is needed, leading to an overstock situation. Alternately, the explicit data may show a positive inventory, and be incorrect, leading to no orders for more products when more products are actually needed resulting in an out-of-stock. Secondly, there are a number of problematic business scenarios that today can only be identified with a visual inspection of the retail store shelf itself in the supply chain. These include the presence of a promotional display where there should be one, the presence of a certain count of products on the shelf, and more. This approach is so expensive to be unrealistic to be applied to all stores; and it also can lead to incorrect data and actions. Third, using RFID technology, users are still limited to explicit facts. A tag read at point x in the supply chain simply means that on that day, that item was at that location. This does not help a user to define where that product should have been, should be now, what amount this is costing the item owner, nor where it is when no reads have occurred. Fourth, measuring approaches often do not account for products that go missing at or between the nodes of the supply chain; theft, loss, damage, and other outcomes lead to incorrect data. Since measuring systems and concomitant actions downstream from the problematic node are based on the assumption of data correctness, many wrong actions can occur from a single data error. Finally, today no approaches are commonly used to tie disparate explicit event data points together to imply a business scenario. Typically inventory data is reviewed for inventory problems, RFID data is reviewed for item tracking, point-of-sales (POS) data is reviewed for sales reporting and consumption. However, there are implicit business scenarios detrimental to consumers and business owners occurring that are not identified.

One of the contemporary methods takes an approach of minimizing the variables utilized to measure inventory downstream in the supply chain. An approach such as this will take a single measure—such as point-of-sales data at the cash register—and assume it to be accurate. The value of this approach is that the fewer variables assumed to be true and utilized, this avoids including measures that are more likely to be incorrect. As such the confidence level can be higher in the derived calculation of the in-stock level of products. However, this approach is still problematic. By taking at least one and often two or three variables as correct, it—by definition—relies on absolute numerical correctness of one or more of the faulty data systems the method is designed to avoid. Unfortunately, every data system in the family is problematic. There are many errors in a point-of-sale system; retailers often will change their sales figures post hoc due to errors they find. RFID readers are not and will never consistently read a movement of every case or item. Further, by relying on absolute amounts of believed inventory, an incorrect value early on or higher up in the supply chain will taint and make incorrect all future absolute values.

Methods and systems are needed to overcome the above mentioned deficiencies.

### BRIEF DESCRIPTION OF THE DRAWINGS/FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram of a contemporary product supply chain

FIG. 2 is a flowchart illustrating steps performed by a retailer to calculate inventory on a store shelf.

FIG. 3 illustrates an example layout of a retail distribution center.

FIG. 4 is a pictorial view of the layout of a contemporary retail store.

FIG. 5 is a flowchart illustrating steps to collect supply chain event data and correlate it with exception scenarios according to an embodiment of the invention.

FIG. 6 illustrates a data model to store user-created application metadata that identifies the criteria describing supply chain business scenarios implicit in supply chain event data according to an embodiment of the invention.

FIG. 7 illustrates a data model to store supply chain event data and product and location taxonomies that describe elements of the supply chain event data according to an embodiment of the invention.

FIG. 8 illustrates an interface to enter information to define exception scenarios and related information, correlate the exceptions with actual data and view the results according to an embodiment of the invention.

FIG. 9 is a block diagram of a computer system on which the present invention can be implemented.

FIG. 10 illustrates an example system according to an embodiment of the invention.

FIG. 11 illustrates an interface to enter information to define criteria for measuring the variances in absolute values of inventory in the supply chain

FIG. 12 illustrates sample sales quantity data.

FIG. 13 is a flowchart illustrating steps to identify out-of-stock events according to an embodiment of the invention.

The present invention will now be described with reference to the accompanying drawings. In the drawings, like reference numbers may indicate identical or functionally similar elements. Additionally, the left-most digit(s) of a reference number may identify the drawing in which the reference number first appears.

### DETAILED DESCRIPTION OF THE PREFERRED EMBODIMENTS

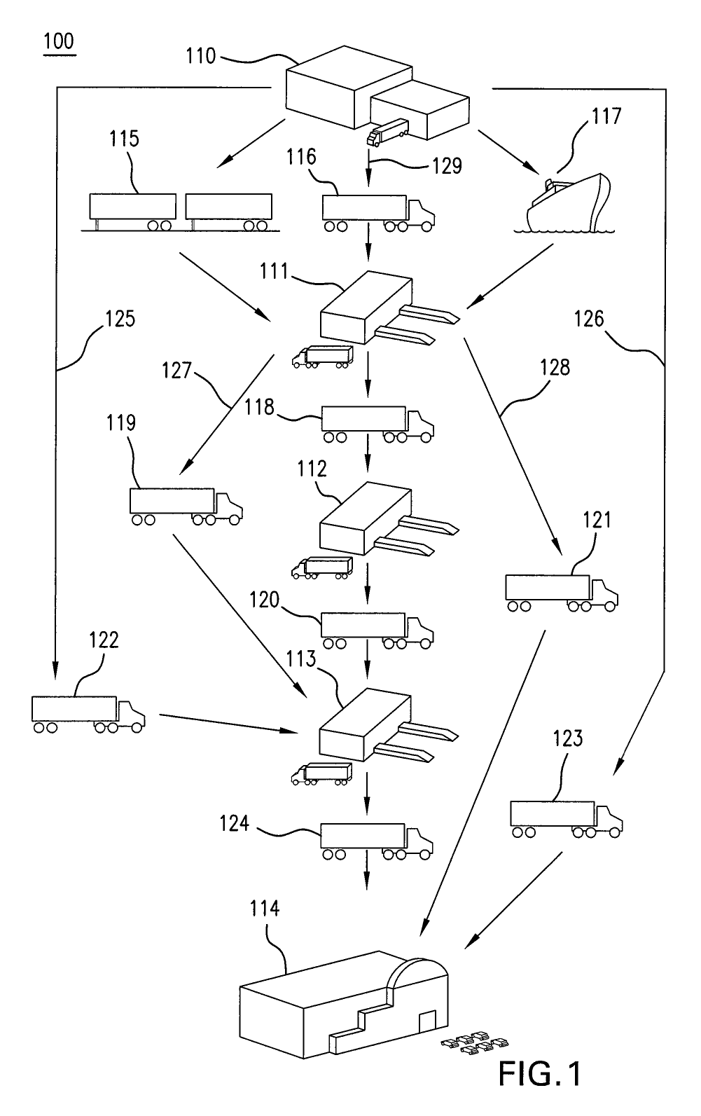

FIG. 1 illustrates a contemporary product supply chain. A supply chain as from the perspective of a retailer would start at their manufacturers' (also known as suppliers or vendors) manufacturing facilities (‘plants’) (110), Typically, the items made in plants 110 would go to one or more distribution centers (DC) (111, 112) owned by the manufacturer, then on to a DC owned by the retailer (113), then on to a retail store (114). Some manufacturers may own just a single DC tier or layer (110), although FIG. 1 illustrates a more advanced supply chain where Tier 1, where more centralized DC's (110) are accompanied by another more remote series of Tier 2 DC's (111, 112). In this configuration, the most common product flow is shown (129) going via rail (115), freighter ship (117), or truck (116) to the Tier 1 DC (111). In some cases, product can flow directly from a plant 110 to a store (114) via a single carrier (123). Alternately, some other downstream flow to the retailer's DC (113), can be used as shown by flows 127, 128, and 125. Retailers try to measure the amount of inventory at each node of this supply chain.

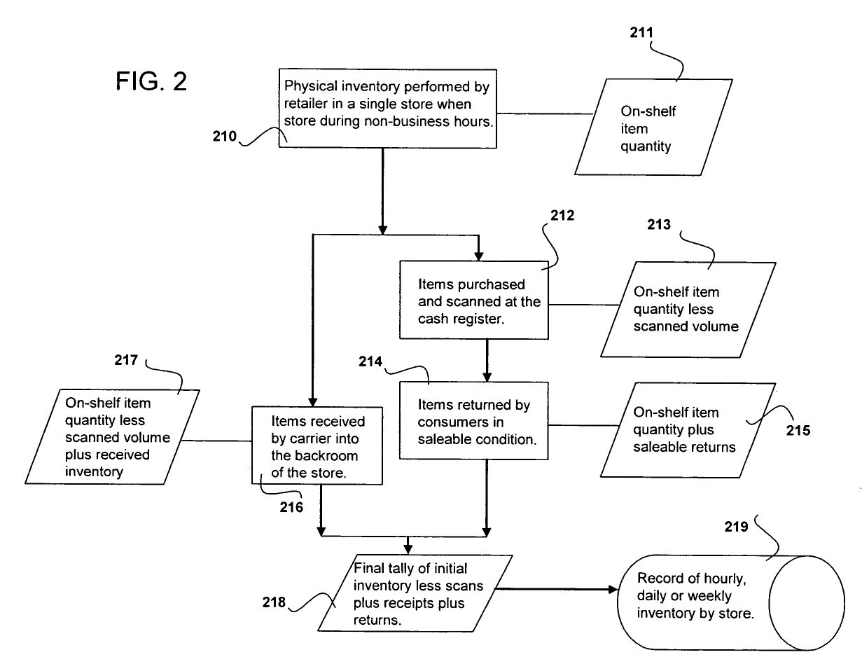

FIG. 2 is a flowchart illustrating steps performed by a retailer to calculate inventory on a store shelf to determine ordering criteria.

In a supply chain, a number of events occur that generate data that may be recorded in computer system. Perhaps the most important for streamlining the supply chain is measuring inventory at the point closest to the consumer. The final retailer DC and the retail store inventory level is most closely correlated with purchases. One approach to keep track of store inventory is a “perpetual inventory method”.

In step 210, retail store employees or audit teams periodically measure the quantity of product on the shelf; this action is called taking a ‘physical inventory’.

In step 211, measurements from step 210 are recorded into a computer system.

In step 212, products are scanned at the point-of-sale (POS) cash register.

In step 213, scanned products from step 212 are recorded which decrements a physical inventory amount leading to a projected current inventory.

By adding in returns (in steps 214, 215), and inbound shipments (in steps 216, 217) as inflows incrementing inventory a computer can store (in step 219) a total projected inventory (in step 218) of what should be on a shelf.

Since it is costly and time consuming to take physical inventories—which are more accurate than perpetual systems—, these perpetual inventory totals of whether a product has enough items on a shelf to stay available for consumer purchase (“in-stock”) have been the primary means of estimating supply chain effectiveness. In this case, Point-of-Sale (POS) scan counts by day, store, and item are critical events. An example of another event would be the count of items outbound from a distribution center being loaded on a truck to go to a store. These figures are also recorded as shipment totals. By aggregating the warehouse physical inventory with the shipments in and out, one can estimate the current amount of inventory in a distribution center. One method of estimating the inventory in the supply chain is of occasional regular physical inventories with perpetual counts of decrements or additions to a base physical count. This method has been problematic and erroneous in many cases and results in items being out-of-stock in between 8% and 25% of the store facings they are supposed to appear in. Systems that measure changes in amounts are calculation oriented, and are highly correct. The problems in the estimations of in-stock amounts come from the measurements of absolute inventory figures at different nodes in the supply chain being wrong.

In the last few years, a new type of event data has become available, generally called radio frequency identification or ‘RFID’. RFID requires ‘tags’ which include serial numbers to be placed on items or cases of items to be counted, and also tag ‘readers’ to be placed at physical locations to count the number of tags that have passed by the reader. Many supply chains augment their event data with RFID reads to become more precise. The RFID ‘serial numbers’—also known as ‘serialized data’—are a more precise instrument than perpetual inventory systems, but are not always available. It is to be appreciated by persons of ordinary skill in the art that the method of determining inventory is arbitrary and includes but is not limited to RFID scans, barcode scans, RuBee radio tag and Serial Shipping Container Code (SSCC) etc.

There are two event types that are derived from Serialized Global Trade Identification Number (sGTIN) data: “retrospective events” which define the event but make no assertions about future state and “prospective events” which make an assertion about future state until contradicted by a subsequent event.

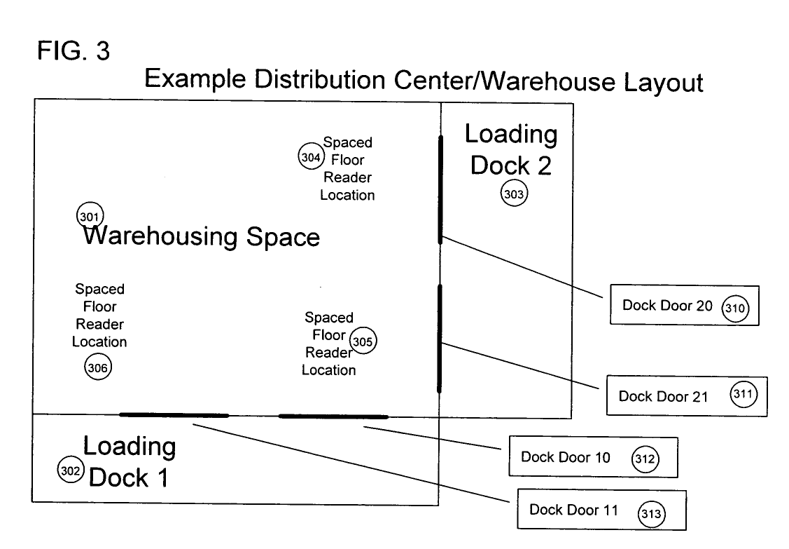

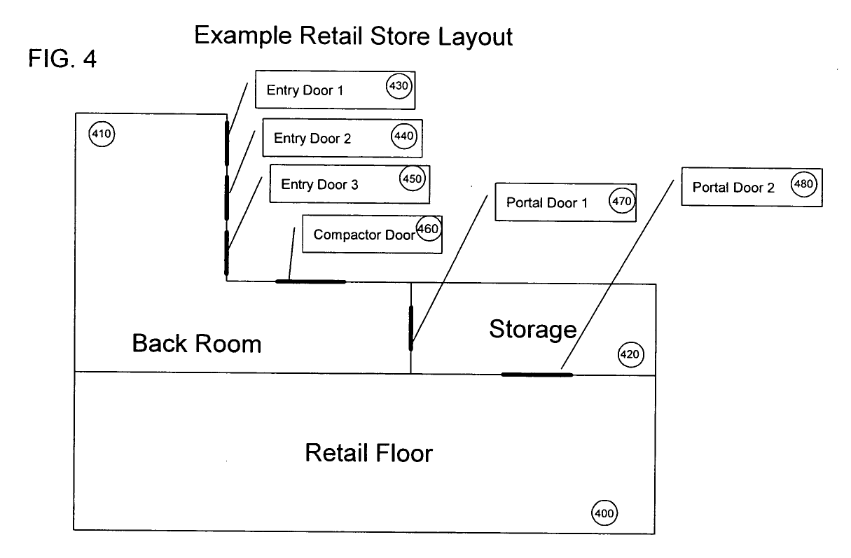

FIG. 3 illustrates an example layout of a retail distribution center. For example in an RFID setting, if product #1 enters a warehouse 301 through a dock door 310, a retrospective event could assert that a product #1 was observed at door 310 at 4:57 PM on January 1st. A prospective event assertion could be that product #1 is in warehouse 301 until this is contradicted by a future event, such as might occur in retail store shown in FIG. 4, where product #1 might enter the store through door 450 at 8:17 AM on January 2nd. In both cases, the specific location, item and date represent an ‘instance’ of a supply chain scenario. For example, a scenario generally called ‘Item in Stock at Warehouse’ may have thousands of current instances in a specific supply chain—meaning on that date the item was available—but the example above on January 2nd with that item is a specific instance. In both of these situations, until product #1 is read, for example, by warehouse RFID reader 305 and confirmed to be in the warehouse; or read by retail store reader, for example, at door 480, and confirmed to be in the store; or counted in a physical audit; then there is no explicit event data stream to confirm the location of this product. As such, ‘Item in Warehouse’ is an implicit scenario.

While both retrospective and prospective events are useful in describing what happened, they do not apply business context to these events to identify a third type of actionable or economically relevant event. This third type of event assertion combines one or more events with the definitions of event flows and locations to identify a supply chain business scenario. The definition of the scenario identifies both the actionable and economic dimensions of an implicit event in order to enable prioritization and ranking as this assertion is used in automated exception processes and analytics.

Embodiments presented herein identify implicit events in the supply chain, using event data including but not limited to Serialized Global Trade Identification Number (sGTIN) tag reads. Implicit events are determined by correlating event or sGTIN data and durations between events with user-created definitions of event flows, locations and products of interest. A processor acquires the definitions from a user defined application metadata of products, locations, and other criteria, combines the user defined metadata with event flows and correlates the event reads with the metadata to identify defined events that are not observed in the event reads, or not observable by the tag readers.

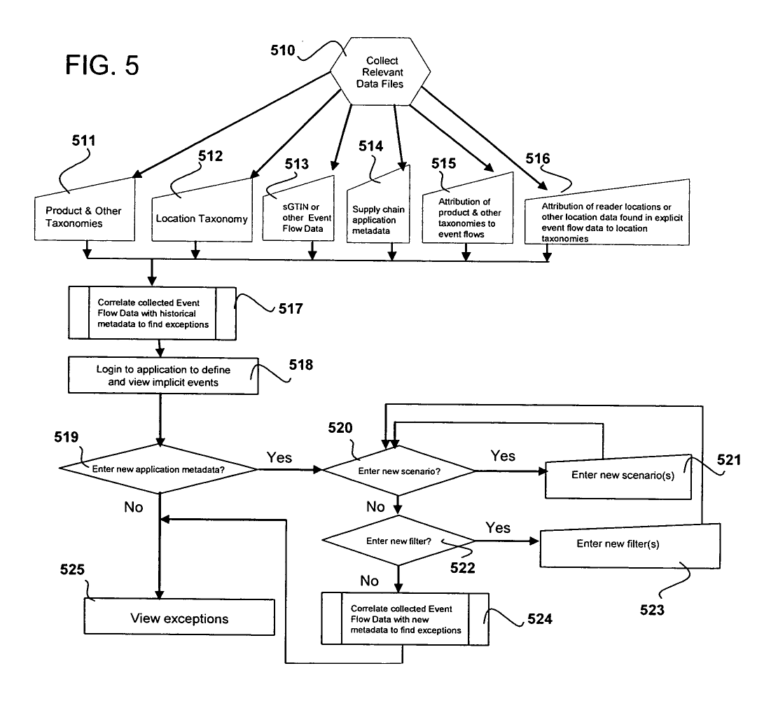

One example of a business scenario is that frequently a product manufacturer will design and create a promotional display case for their items. The promotional display may be a colorful, floor-ready setup which includes a set of the items to be promoted. The retailer is supposed to take possession of this in their supply chain, get it to stores, and have store employees receive it in the back room, e.g. area 410 and move it to the retail floor 400. Once all the products on the display have been purchased by consumers, the store employees are to move the cardboard display to the store's box crusher, outside the door to the crusher 460. Unfortunately, in today's supply chain, retail store employees often don't take the time to move the promotional display from the back room out on to the floor, as it's easier for them to unload regular cases of product—and because it would require them to move current promotional displays already on the sales floor 400. In these cases, promotional displays stuck in the back room 410 actually cost both the retailer and the manufacturer, as it creates a lag in the supply chain. Often in-store displays are tied to other advertisements such as television ads, all of which are timed to coincide with the presence of the promotional display to increase purchase behavior. The products if perishable or seasonal need to be displayed on the sales floor as soon as possible and languishing drives them closer to their expiration or date or irrelevancy. Typically these displays include a special lower item cost for the retailer that is subsidized by promotional trade funds of the manufacturer. If the promotion is not sold through the retailer, lower gross margins result. Perhaps most importantly, the items in the promotional displays are counted as inventory on the store floor 400, and as such the regular shelf might be out-of-stock, but the store is not notified by since it is believed that there are items available—the ones in the promotional display—which then would delay the ordering of additional product. The scenario presented may be termed as ‘Promo Display Stuck in the Back Room’. Embodiments presented herein provide a systematic approach to using event flows to infer that the scenario is indeed true for a certain set of stores and items at a point in time. Specific event flow data that might imply this is as follows. Product #1 was observed entering a retail store through door 440 at 8:17 AM on January 2nd retrospectively. FIG. 4 illustrates an example retail store layout. Sensors or readers may be present at, for example, entry doors (430, 440, 450) to the back room, portal door 470 into storage and portal door 480 onto the retail floor. In an example, the retail store layout may be used to describe location taxonomy data (512 in FIG. 5). Events associated with the promotional display-either by item number or sGTIN—are monitored. The promotional display is expected to move on to the sales floor evidenced by event data such as RFID reads, or by seeing POS scan data for a promotional item. If a promotional item does not move onto the sales floor or is not sold—the absence of an event—the present invention would describe this as an instance of a scenario where the store has failed to execute on a promotion. This scenario would be identified due to the fact that the item is a promotional item and no subsequent events have been recorded thereby indicating that the product has not been moved to the sales floor for sale to the customer. In an embodiment, economic and actionable parameters may be associated with this event, and based on the value of the parameters, this event could trigger a message to a merchandiser to visit this store or tie directly to a trade funds management system to reduce a promotional payment.

The key scenario that needs to be measured and identified with an implicit event approach is a product ‘out-of-stock’ event. An out-of-stock event implies that the consumer—if brand loyal—may switch retailers to find one where the product is in stock. This is the worst possible consumer behavior for a retailer, and much worse than losing the margin on that specific sale, as it represents the risk of losing that consumer's regular visits forever. It is also disadvantageous for the manufacturer as alternatively the consumer may purchase a competitive brand that is in stock. Out-of-stock events are highly prevalent in today's supply chains.

Currently, a number of inferior methods abound for identifying out of stock events. Like the promotional display scenario described above, manufacturers may send out their own staff or brokers to physically check the shelf. Retailer physical inventories also can reset errors that have occurred where the perpetual inventory count says there is product available when in fact none is on the shelf. No specific supply chain event exists that is computerized to identify product out-of-stocks. Since many items in today's consumer supply chain often sell only between zero and five times per day, the magnitude of miscounting even one or two becomes material. As such, only an approach that can utilize a baseline of data to aggregate these small daily totals mitigates errors of one or two items. However, using embodiments presented herein, an out-of-stock scenario is much more likely to be identified. That is because a set of existing events can be calculated—including the durations between these events—to identify an instance of the out-of-stock scenario.

Ad hoc methods for determining implicit events manually by experienced knowledge workers over constrained data are tedious and expensive. Manufacturers may hire brokers to send teams of people out to stores to check for the presence of the promotional displays. This approach is much more costly than using a computer implemented method as described herein to detect implicit events, and can only cover a sample of the total stores—and also includes errors in the counts made by the broker teams. Sometimes manufacturer personnel attempt to visit stores to see if the promotions are out. From time to time retail management will find promotional displays stuck in the back room. Finally, sometimes analysts with a great degree of experience can visually look at sales totals for promoted items in promotional periods in the aggregate and estimate they look low based on years of experience, and thus infer that one of the possible causes must be that promotional displays are stuck in the back room. None of these methods are accurate nor do many rule out other possible causes of poor sales performance for these items.

In an embodiment, implicit events are identified in the supply chain, using event data including but not limited to Serialized Global Trade Identification Number (sGTIN) tag reads. Implicit events may be determined by correlating variances in event or sGTIN data with user-created definitions of event flows, locations and products of interest. A processor acquires the definitions from user defined application metadata of products, locations, and other criteria, combines the user defined metadata with event flows and correlates the event reads with the metadata to identify defined events that are not observed in the event reads, or not observable by the tag readers. Embodiments presented herein allow users to handle identifying out-of-stocks in the presence of a huge amount of data. Embodiments presented herein provide a software application and a method for identifying specific scenarios in a supply chain. A user collects supply chain data, and then defines in application metadata the specific event types, durations, and characteristics that define a likely instance of a supply chain scenario. The software application applies those definitions to a regular infusion of supply chain event data to identify and display the user-defined scenarios.

FIG. 5 illustrates a flowchart showing steps to collect supply chain event data and correlate it with user-defined scenarios according to an embodiment of the invention. According to an embodiment of the invention, a scenario is identified by applying calendar or time criteria selectable from a taxonomy (511), locations of interest from a taxonomy (512), and specific products or product displays (511) to commonly available search technologies. In these technologies, search criteria are applied first to a stream of event data which filters out a majority of records. The next step in the scenario identification process is to apply the specifics of implicit events, such as statistically significant changes in key measures between a baseline and test period for these filtered records. Records in the test period that include significant changes from baseline are finally the end result and represent identified product flows that are specific instances of events that meet the scenario criteria (517, 524).

In Step 510, sources of relevant information are identified. These sources of information do not represent information added by users at run-time (information is added by the user in step 519). These sources are typically in the possession of a user running the application, and are preferably in the format of a computer readable file or files. In some situations, the user may not own the data, but may be able to access it for the purposes of this method. Finally, if the user does not own or cannot access the data, the application can run without all of the relevant information.

Users may want to create exception scenarios for specific items. For example, if a company sells Chewy Chews Granola Bars, the user may want to identify places in the supply chain where scenarios have occurred leading to the product not being on the shelf in quantities sufficient to ensure a prospective consumer could purchase it (i.e. avoid an ‘out of stock’ event). Alternately, a user may want to view scenarios related not only to Chewy Chews Granola Bars, but all of its sister products in a family called Ready-to-Eat Snacks. In this case, product taxonomy (511) is used to identify various product families and classifications in the Ready-to-Eat Snacks category. In step 511, a product taxonomy may be provided in a file format to the application. Product taxonomy 511 includes but is not limited to product categories, subcategories, segments, finelines or other product bundles. Product taxonomy 511 also includes product attributes. Product attributes include but are not limited to product characteristics, tags, or adjectives applied to items that also apply to other products, and hence individual attributes can have a number of products with that attribute. In an embodiment RFID data may be used and at least one of the attribute or family hierarchies must terminate with a product identifier that can be linked to identifiers found in Step 513. Product and location data may be collected through automated methods, such as product and location master data from the Electronic Product Code Information Service (EPCIS), retailer and manufacturer specific master data elements or entered directly via a user interface. Product taxonomy 511 allows the instances of event data to be defined at hierarchically higher levels on the taxonomy as needed, and to have these definitions cascade to apply to lower levels, thereby reducing the data entry tasks. In addition to product taxonomies, other taxonomies may be loaded such as calendars (time dimension taxonomies) for read and other event flow data to be grouped by. Other taxonomies could include promotion groups or consumer clusters.

Likewise to product taxonomies, users may want to identify specific locations that are singularly or repeatedly problematic. These locations may represent bottlenecks in the supply chain or loci of poor decision making by trading partners. Alternately, users may want to view all exception scenarios tied to a bundle of locations. For example, these might be all the stores served by a specific distribution center. The user might want to see all stores that are larger than 100,000 square feet, regardless of the distribution center serving them. In these two examples, the distribution center is considered part of a ‘hierarchy’, implying there might be other layers of the hierarchy with increasingly smaller cardinality (e.g. one Tier 1 distribution center has 5 ‘children’ Tier 2 distribution centers it serves, each of the Tier 2 distribution centers having 10-30 ‘children’ stores it serves). Alternately, the store size is considered a characteristic (i.e. there is typically only one ‘level’ in the hierarchy of association). In step 512, a location taxonomy is presented to the application in a file. In an embodiment utilizing sGTIN or RFID data, one of the taxonomies will terminate in a ‘child’ group which includes locations that can be tied to the event data in Step 513. Alignment of reader locations to more general ‘semantic’ definitions are location specific and may be collected through automated methods, such as the EPCIS, retailer and manufacturer specific definitions or entered directly via a user interface. An example of a general definition of a reader location might be ‘warehouse floor’ and actually apply to a series of readers in the same family, such as the locations in FIG. 3 labeled 304, 305, and 306.

Scenarios have their root in explicit measurements of inventory, orders, or other data from the supply chain. These are typically static point-in-time measures of estimated inventory, sales or order amounts. These measured definitions typically stay the same for many months in serial, and measurements are taken at consistent points in time. For example, event data may include that on a specific date, there were 24 Chewy Chews Granola Bars on the shelf of a store in Richmond, Va. Alternately, it could be a record showing that a specific case of granola bars, tagged with a serial number or sGTIN identifier, passed a specific RFID reader in the backroom of a store in Baltimore, Md. sGTIN data is the list of reads by date and reader code. sGTIN data provided in a file might be only the Electronic Product Code (EPC) standard data fields, a subset of those fields, or those standard fields with additional fields. For RFID data, the explicit data is often provided by an enterprise object repository internally available to the owner of the application, a trading partner, or RFID middleware software outside an enterprise object repository.

In step 513, a file is provided that includes explicit event flow data. If the event flow data is serialized, the file also includes information linking the serial number or sGTIN to a specific product. By this link, the serialized data can tie to the product taxonomies provided in Step 511. Linking of products to event flow data occurs at the highest possible level on the product taxonomy. For example, all sGTINs from one family may have common characteristics, and therefore the attribution would be at the family level. However, this behavior can be radically different for different products and the attribution may need to be performed at the Global Trade Identification Number (GTIN) or sGTIN level. The explicit data, whether serialized or not, also includes a tie to a location that can be correlated to data provided in Step 512.

In Step 514, the application loads historical metadata in which users may have defined scenarios that are of interest. Historical metadata includes but is not limited to a) generic scenario definitions and/or b) ‘filters’ that limit the scenario definition to specific locations, products, or other attributes. Further, the filters tied to general scenario definitions comprise c) an ‘exception event’. In this step, prior scenarios, filters, and/or exception events are loaded.

Providers of explicit data or the owner of the application will have data linking products and locations to explicit data. This information will often be written to separate files. In step 515, the product links to explicit data are loaded; in addition, non-product links are made, such as to time taxonomies or other hierarchies and attributes. In step 516, the location links to explicit data are loaded.

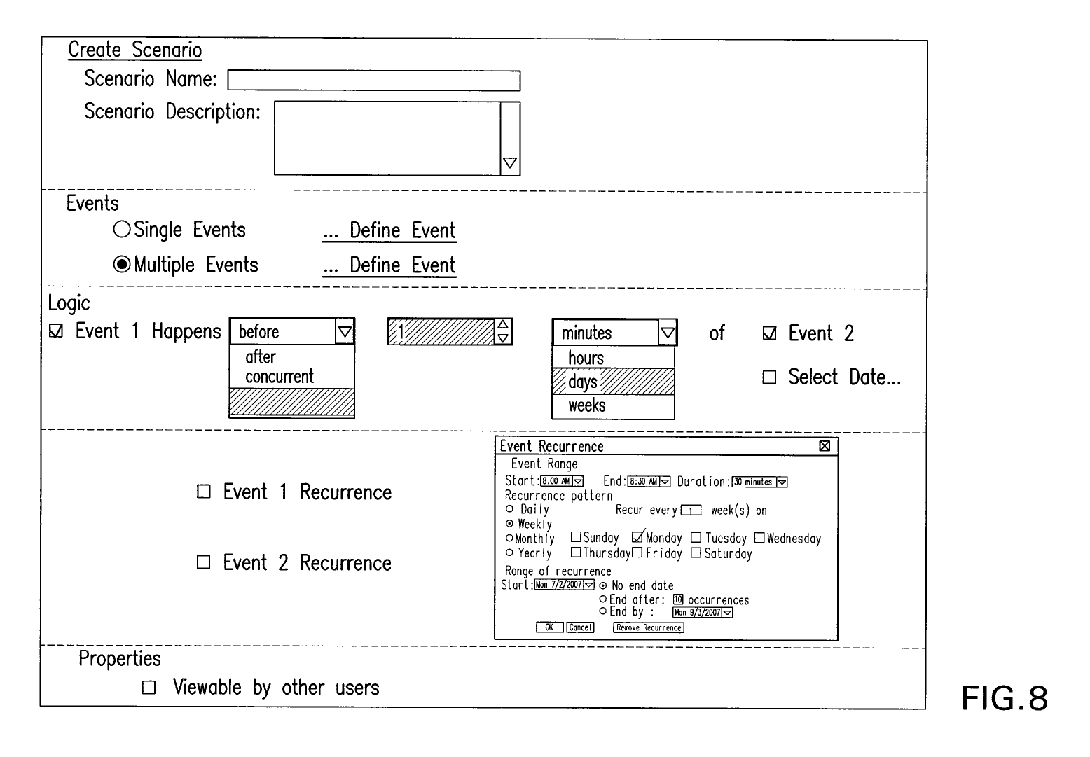

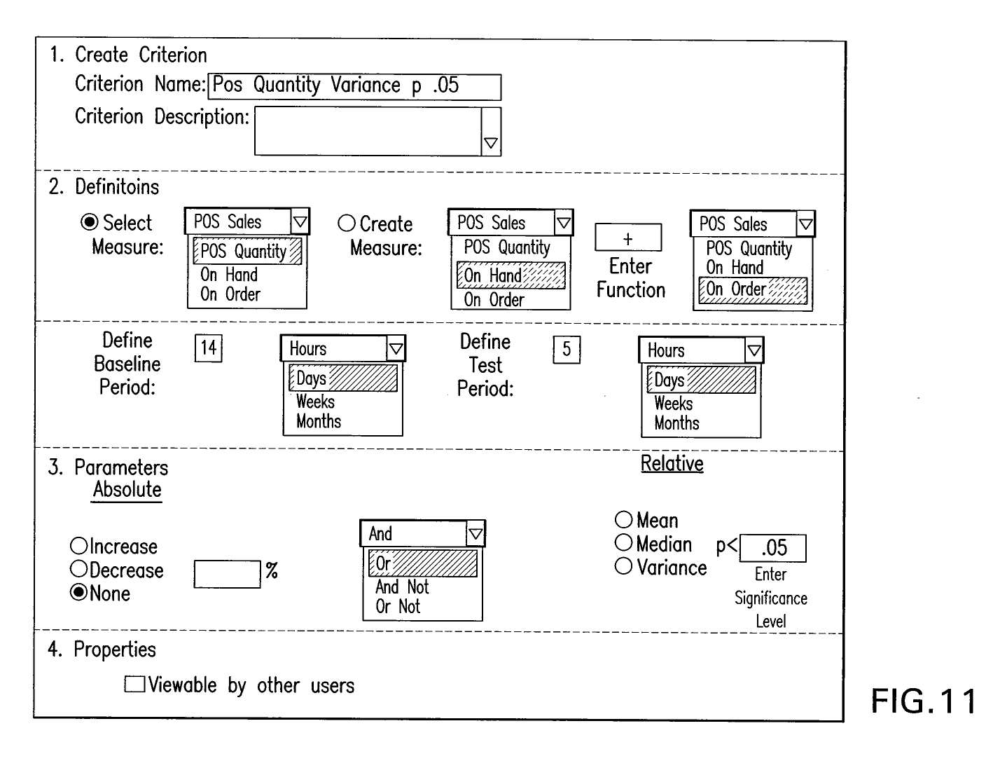

At specific intervals, the application will receive new data. These could either be new descriptive data—such as new taxonomies, or it could be new metadata. New taxonomies occur when manufacturers or retailers change their product hierarchies or reassign products to different hierarchies. New application metadata may come from new users using the invention, each of whom has specific scenarios they are looking for. Alternately, an existing user may have new responsibilities or areas of interest. For example, if a company releases a new item, new application metadata will need to be entered to create a new scenario to trap. A user will have to enter new non-historical metadata (519). FIG. 8 illustrates an interface to enter information to define exception scenarios and related information, correlate the exceptions with actual data and view the results according to an embodiment of the invention. Using a screen such as this, a user would be able to create criteria for a new implicit scenario. When the new event flow data comes in, the necessary pieces are available to match this new metadata and find all the event instances that occurred. FIG. 11 illustrates an interface to enter information to define exception scenarios, specifically one of the criteria that shows significant variance in key measures. Metadata created from information entered by a user via the interface illustrated in FIG. 11, when applied to measured values enable detection of an implicit event. This occurs in Step 517.

The events 510 through 517 can be done with a user logging in. For the method to become valuable, a user needs to log in, to view—and analyze and then act on—the instances that are problematic. In step 518, a user logs in to the system. The user will either be there to view the automatically identified instances, or will be there to define new exception events, or both.

In an embodiment, a user defines a scenario to identify the implicit events specific to that scenario. In another embodiment, the application may anticipate that the user might want to see all event instances that don't conform to the ideal product flow. In this case, a user is not identifying all the causes or scenarios where the supply chain is ‘broken’ or not streamlined. Rather they are identifying what is supposed to happen, then requesting to see everything outside that profile.

In Step 520, the user decides to create either a new scenario or customize an existing scenario, or move on to working with filters. In Step 521, if it is determined in step 520 that the user decides to edit an existing scenario or create a new scenario, then the user edits an existing scenario or creates a new scenario and saves the changes.

In Step 522 it is determined whether a new filter is to be created or an existing filter is to be modified.

In Step 523, a user may either create a new filter or edit an existing filter and associate the filter with an existing scenario. A filter is an object that defines limits to the scenario definition, to specific locations, products, or other attributes. It can be thought of as a set of personal preferences that need to be applied to all the exception events to bring back instances that tie together in some way. For example, a user may want to see only those instances related to Chewy Chews Oat Cereal but not Chewy Chews Granola Bars, and only for events in the last 1 week. This filter, applied to the scenario described above as ‘Store Trashes Promo Display’ when executed will return all the instances of exception events within that scenario, and leave out the instances where the product is something other than Chewy Chews Oat Cereal. This subset of all exception events might be more actionable or relevant to the user. The final step the user is required to take is applying the new or existing filter to specific scenarios.

Once the user has concluded their work with application metadata, in Step 524, the application applies the new application metadata (i.e. scenario/filter combinations) to the new event flow data, and finds all the instances of interest.

In an embodiment, RFID tags are used in steps 524 and 517 as follows: as sGTIN event data is collected, a process 517 or 524 evaluates the sGTIN event data to identify implicit events—defined in step 521 and 523—by correlating actual event flow with user definitions of a predicted or planned event flow. For example, if in a planned event flow, a product is supposed be on a shelf in a particular time frame and according to the actual event flow the product is not on the shelf in that time frame, then process 517 or 524 detects the variance in reads and identifies the implicit event that occurred. The automatic processes may then notify a user of the discrepancy in actual and planned event flow in a number of ways (525). For example, the automatic process may generate a report detailing the implicit event, produce a flat file using Extract, Transform and Load (ETL) software, allow a user to login to a website or server and display a message, e-mail a user with the implicit event and/or text message a user with the implicit event. As subsequent sGTIN event data is loaded, this correlative activity spans both the context of the new sGTIN data and existing data.

In embodiment, the user could simply view the exception instances in step 525. The user may qualitatively or quantitatively analyze the results for future knowledge or some communication or later action. In another embodiment, the user may view the results and take action on one or more instances, where the action manually helps fix the problem, such as a telephone call to a retail store manager or an email to a merchandiser. In yet another embodiment, the user may view the instances to estimate causal factors not readily apparent in a scenario. For example, if the scenario is Store Out-of-Stock and the user sees most of the instances are stores served by a single retail distribution center, the user might infer that the cause is more specific to the distribution center and the store being out-of-stock is a symptom of a distribution problem at that distribution center. In yet another embodiment, the user might want some subset of the exceptions to be sent to one or more operational applications, such as an ordering program to have products ordered to increase the supply chain flow for one or more products. Alternatively, the user may aggregate statistics about exception instances. For example, the user might want to see the total quantity that should be on the shelf that is not, or the total number of promotional displays ‘Stuck in the Back Room’ regardless of which specific stores this is occurring in.

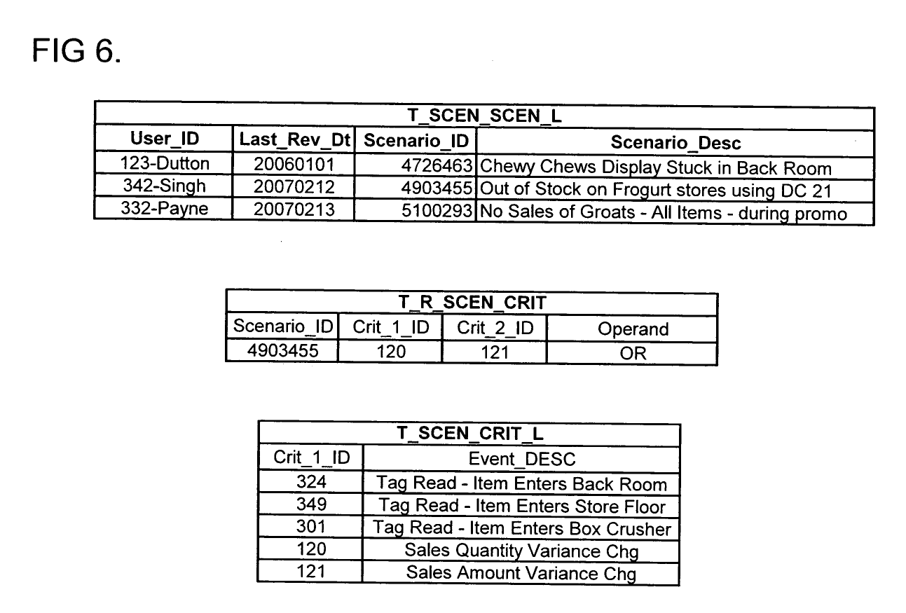

FIG. 6 shows an example data model or data structure used to store data entered into user interfaces shown in FIGS. 8 and 11. The screenshots in FIGS. 8 and 11, illustrate fields to define one of the criteria that might singly define a scenario, or be combined with other criteria to define a scenario. A user may enter a scenario where the count of RFID reads changes significantly; or to find where the variance in quantity has changed significantly. In this case, the user will set up a scenario to look for called, for example, “Chewy Chews Sales Quantity Variance”. Embodiments also capture a user's identification, so that others who log in separately don't see the scenarios specific to a particular user. Figures are populated into a table which includes the Chewy Chews scenario and event types that are relevant. A separate table may include a distinct list of criteria a user has to choose from to define a scenario. One of the advantages of the embodiments presented herein is that they can look for changes to data flows and ascribe that as an event, where another flawed system might infer specific values and attempt to use those to make supply chain actions. In the scenario to criteria table, the application might also capture the other data. Further, the user could enter data in the interface shown in FIG. 11 or in any other interface that would populate a model such as the one shown in FIG. 6.

The fields in FIG. 6 are listed here with their definition and significance:

1. User_ID associates a specific user or computer with their associated scenarios. This allows the visual interface to display to a user only their scenarios and information. This is found in the Scenario table (T SCEN_SCEN_L).

2. Last_Rev_Dt is a number tied to a calendar date on which a user last edited application metadata tied to that scenario. This is helpful for users to sort their scenarios based on the ones they've used recently. It may also help an administrator clean out older scenarios that have not been used in some years. This is found in the scenario table (T_SCEN_SCEN_L).

3. Scenario_ID is a numeric identifier associated with a specific user's scenario. Using a number rather than a text identifier helps a computer system performs its tasks faster. This is found in the Scenario table (T_SCEN_SCEN_L).

4. Scenario_Desc is a text identifier created by a user for a specific scenario they are defining criteria for. This will be shown in the user interface for the user to describe the criteria or the goal of the scenario or both. This is found in the scenario table (T_SCEN_SCEN_L).

5. In the Event table (T_R_SCEN_EVENT), the presence of Scenario_ID allows a database to tie events to the descriptive information about Scenarios in the scenario table (T_SCEN_SCEN_L).

6. Event_{—}1_ID is a field for a user to add or apply events under the rubric of a scenario. A scenario includes one or more explicit events, and information about their duration, location and lack of next event. As such, the first event in a scenario is listed in this column. This field is in the events table (T_R_SCEN_EVENT).

7. Event_{—}2_ID is similar to event 1 but is the second event, if needed, in the scenario definition. This field is in the events table (T_R_SCEN_EVENT).

8. MAX_Duration_Hrs is a field used to insert a specific number of hours for a processor to count after the first event before the second event. In the case shown in FIG. 6, the user has entered 48 in this field. This means if the second event happens after the maximum of 48 hours after the first event is recorded, this event instance—the product, location, promotion and dates involved—is a record that qualifies as an event instance to be displayed as one instance of the scenario. This field is in the events table (T_R_SCEN_EVENT).

9. MIN_Duration_Hrs is similar to MAX_Duration_Hrs, but uses a threshold that qualifies only if the second event occurs before the MIN_Duration_Hrs. This field is in the events table (T_R_SCEN_EVENT).

10. First_Event is a field used to allow a user to choose between Event 1 and Event 2 to decide which event occurrence should mark the start of the duration or next action. This field is in the Events table (T_R_SCEN_EVENT).

11. Event_{—}1_ID field in the T_SCEN_EVENT_L table allows a user to name each event. Users may want to re-use events across different scenarios. As such, the invention provides for event metadata as defined by the user. Event_{—}1_ID is a numerical field that may be referenced by the T_R_SCEN_EVENT table to associate specific durations and identification information with events.

12. Event_DESC is a field where a user may name a specific event for the graphical user interface to display an event in a recognizable format. This exists in the Event Description table (T_SCEN_EVENT_L).

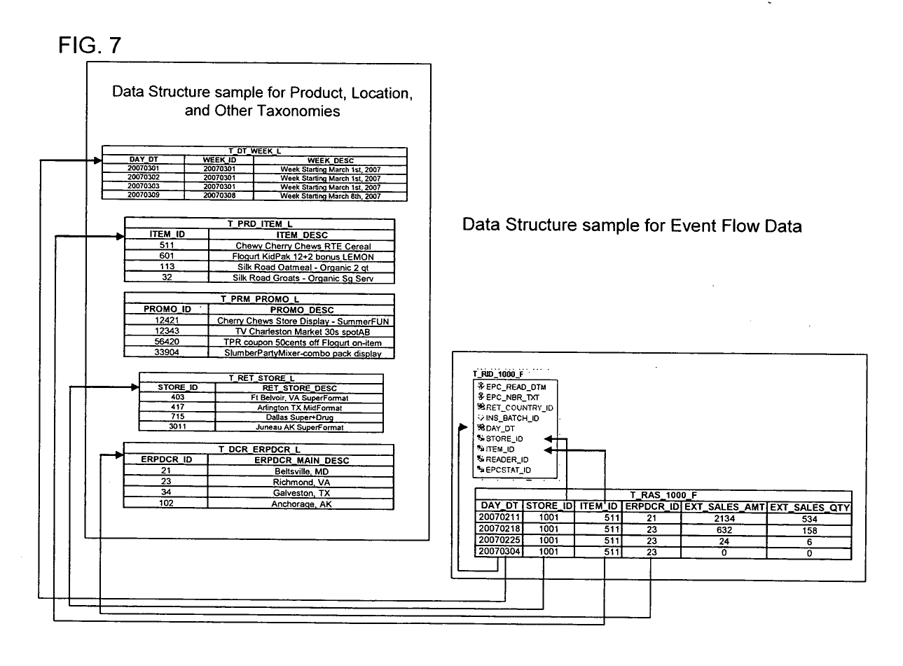

FIG. 7 illustrates an exemplary data model to store supply chain event data and product and location taxonomies that describe elements of the supply chain event data according to an embodiment of the invention. The fields illustrated in FIG. 7 include:

1. DAY_DT is a field for numerical codes tied to specific dates. The significance of this is that explicit supply chain events will have a date on which they occurred. This exists in table T_DT_WEEK_L.

2. WEEK_ID is a numerical field with a numerical code for each week in every year available. The use of numerical data rather than text helps to make a computer system run faster. This field is in the table T_DT_WEEK_L.

3. WEEK_DESC is a text field describing the week that the event occurred in. This field is in the table T_DT_WEEK_L.

4. ITEM_ID is a numerically distinct identifier for a specific product. An example of a product might be Cinnamon Life Cereal 24 oz. Box. It is not a universally distinct specific box of cereal, as might be found in Jane Doe's home in January, 2008. It is rather a type of product, of which thousands are manufactured, and only one of those specific thousands of the item in the ITEM_ID column actually makes it to Jane Doe. This field is in the table called T_PRD_ITEM_L.

5. ITEM_DESC is a field for the text description of an item. It is primarily used in user interfaces to enabled users to identify and work with an item. This field is in the table called T_PRD_ITEM_L.

6. PROMO_ID is a field for the numerical representation of a marketing promotion. If supply chain scenarios involve promoted items, promotional displays, or seasonal items, enable users specific that criterion as part of the implicit scenario. This field is in the table T_PRM_PROMO_L.

7. PROMO_DESC is a field for the text description of a promotion. It enables users to identify the type of promotion and other information about it. This field is in the table T_PRM_PROMO_L.

8. STORE_ID field is a subset of location taxonomy. The STORE_ID field holds numeric representation of a specific store in the supply chain. This field is in the table T_RET_STORE_L.

9. RET_STORE_DESC is a field for the text description of a store. It enables users to identify a store, its location, and type. This field is in the table T_RET_STORE_L.

10. ERPDCR_ID is a numeric identifier for distribution centers available to be trapped when a user's Scenario includes requests tied to distribution centers. These actual distribution centers are identified first with numerical codes. This field is in the table T_ERPDCR_L.

11. ERPDCR_MAIN_DESC is a field for the text description of a distribution center. It enables users identify a warehouse its location, and type. This field is in the table T_ERPDCR_L.

12. Table T_RAS_{—}1000_F includes specific transactions in a supply chain. These are the explicit events which signal that a product is or has been at a specific place in the supply chain at a specific time. In this case, this table lists the product sales on a retail store floor. In this table exists a number of fields that have been described above. These include DAY_DT, STORE_ID and ITEM_ID. The additional fields here are EXT_SALES_AMT and EXT_SALES_QTY.

13. EXT_SALES_AMT is a field showing the total sales in local currency sold on a day for that item at that retail store when serviced by that distribution center. This field is in the table T_RAS_{—}1000_F.

14. EXT_SALES_QTY is a field showing the total quantity sold on that day for that item at that retail store when serviced by that distribution center. This field is in the table T_RAS_{—}1000_F.

15. Table T_RID_{—}1000_F includes a number of fields tied to specific sGTIN identifiers and explicit events that have occurred. In this table a number of fields exist that have been described above, which are STORE_ID, ITEM_ID, and DAY_DT.

16. EPC_READ_DTM is the time of the tag read. This column, along with EPC_NBR_TXT, form a unique data primary key for table T_RID_{—}1000_F. This field is found in table T_RID_{—}1000_F.

17. EPC_NBR_TXT is the RFID tag identifier. This column, along with, EPC_READ_DTM, form the primary key for table T_RID_{—}1000_F. This is the product serial number for the instance of the item in question. This field is found in table RID_{—}1000_F.

18. RET_COUNTRY_ID is a unique identifier for the country and retailer combination. This is primarily used as the basis for physical data partitioning and is not necessary for analysis of the data. This field is found in table T_RID_{—}1000_F.

19. INS_BATCH_ID is to identify the instance of a data loading job which loaded the record. This enables auditing of loads and data-load performance metrics.

20. READER_ID identifies a specific RFID reader within the store or warehouse that performed the item read for the event. This field is found in table T_RID_{—}1000_F.

21. EPCSTAT_ID identifies an implied status of the sGTIN for this read. This status is determined by the sequence of prior reads as well as the location of the reader associated with this record. It is a description of the transition of a product has as it moves across the RFID tag reader. Examples of records found in this field might include:

a. EPC product on sales floor

b. EPC transition from sales floor to back

c. EPC product Received

d. EPC transition from backroom to sales fl

e. EPC product shipping

f. EPC product in backroom of store

g. EPC product inactivity

h. EPC product being stocked on sales floor

FIG. 8 illustrates an interface to enter information to define exception scenarios and related information, correlate the exceptions with actual data and view the results according to an embodiment of the invention. For example in FIG. 5, step 521 a user may utilize the interface illustrated in FIG. 8 to create a scenario. In creating a scenario, the user may name the scenario and add attributes to the scenario. Some of the data entered or selections made here are represented in text and numerical values in the table T_SCEN_SCEN_L in FIG. 6. During the steps of making selections in FIG. 8, a user selects either Single Event or Multiple Events to define the scenario. When the user makes this selection, they are directed to a hyperlink called ‘Define Event(s)’. When this link is clicked the user is directed to a user interface such as that shown in FIG. 11. Between FIG. 8 and FIG. 11, the fields in FIG. 6 will be completed in order to make a coherent and usable Scenario for Step 521 in FIG. 5 to be completed.

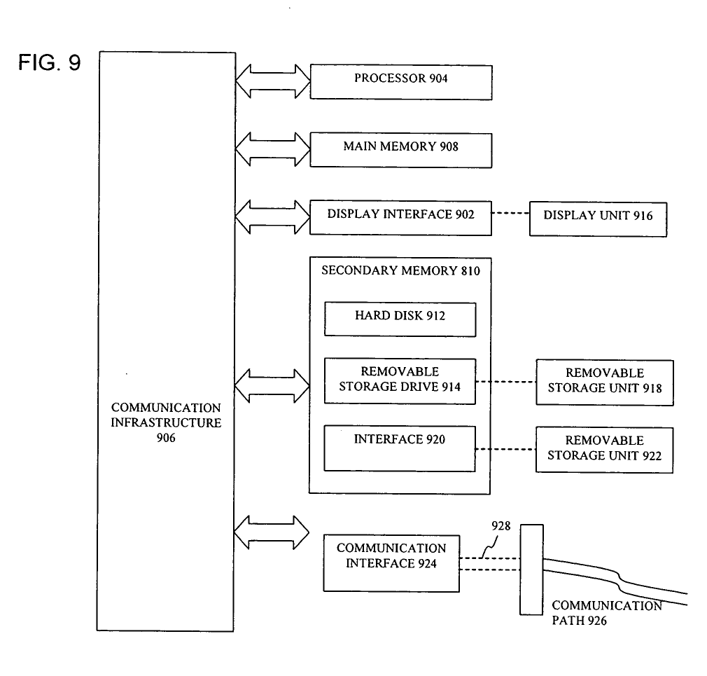

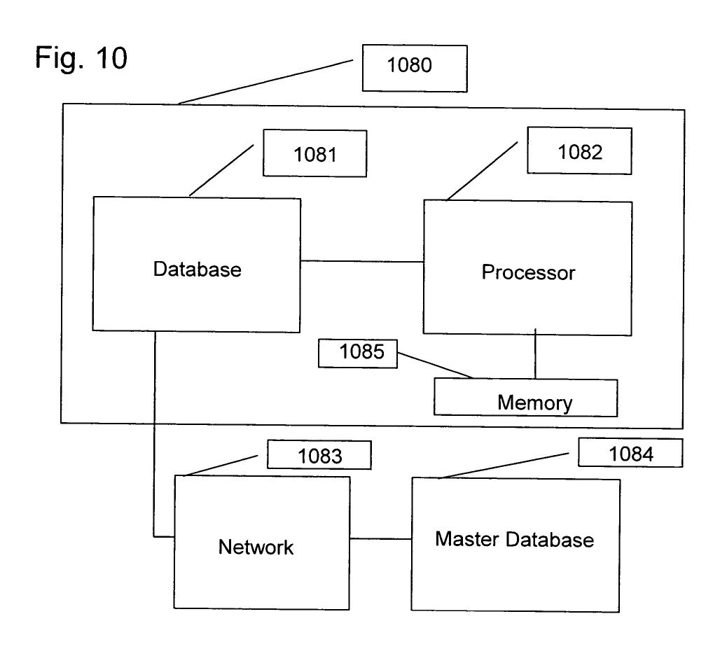

FIG. 9 diagrams a general purpose computer system and is provided for completeness. The present invention can be implemented in hardware, or as a combination of software and hardware. Alternatively, embodiments may be implemented in the environment of a computer system or other processing system as illustrated in FIG. 10. The computer system includes one or more processors, such as processor 904. Processor 904 can be a special purpose or a general purpose digital signal processor. The processor 904 is connected to a communication infrastructure 906 (for example, a bus or network). Various software implementations are described in terms of this exemplary computer system. After reading this description, it will become apparent to a person skilled in the relevant art how to implement the invention using other computer systems and/or computer architectures.

The computer system also includes a main memory 905, preferably random access memory (RAM), and may also include a secondary memory 910. The secondary memory 510 may include, for example, a hard disk drive 912, and/or a RAID array 916, and/or a removable storage drive 914, representing a floppy disk drive, a magnetic tape drive, an optical disk drive, etc. The removable storage drive 914 reads from and/or writes to a removable storage unit 918 in a well known manner. Removable storage unit 918 represents a floppy disk, magnetic tape, optical disk, etc. As will be appreciated, the removable storage unit 918 includes a computer usable storage medium having stored therein computer software and/or data.

In alternative implementations, secondary memory 910 may include other similar means for allowing computer programs or other instructions to be loaded into the computer system. Such means may include, for example, a removable storage unit 922 and an interface 920. Examples of such means may include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to the computer system.

The computer system may also include a communications interface 924. Communications interface 924 allows software and data to be transferred between the computer system and external devices. Examples of communications interface 924 may include a modem, a network interface (such as an Ethernet card), a communications port, a PCMCIA slot and card, etc. Software and data transferred via communications interface 924 are in the form of signals 928 which may be electronic, electromagnetic, and optical or other signals capable of being received by communications interface 924. These signals 928 are provided to communications interface 924 via a communications path 926. Communications path 926 carries signals 928 and may be implemented using wire or cable, fiber optics, a phone line, a cellular phone link, an RF link and other communications channels.

The terms “computer program medium” and “computer usable medium” are used herein to generally refer to media such as removable storage drive 914, a hard disk installed in hard disk drive 912, and signals 928. These computer program products are means for providing software to the computer system.

Computer programs (also called computer control logic) are stored in main memory 908 and/or secondary memory 510. Computer programs may also be received via communications interface 924. Such computer programs, when executed, enable the computer system to implement the present invention as discussed herein. In particular, the computer programs, when executed, enable the processor 904 to implement the processes of the present invention. Where the invention is implemented using software, the software may be stored in a computer program product and loaded into computer system 500 using raid array 916, removable storage drive 914, hard drive 912 or communications interface 924.

In other embodiments, features of the invention are implemented primarily in hardware using, for example, hardware components such as Application Specific Integrated Circuits (ASICs) and gate arrays. Implementation of a hardware state machine so as to perform the functions described herein will also be apparent to persons skilled in the relevant art(s).

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

FIG. 10 illustrates an example system according to an embodiment of the invention. Computational unit 1080 includes a database 1081 coupled to a processor 1082. Computational unit 1080 is coupled to a master database 1084 via network 1083. Processor 1082 is used to run code which implements the steps illustrated in FIG. 5 and generate the user interface illustrated in FIG. 8. In an embodiment, the interface illustrated in FIG. 8 is a Graphical User Interface (GUI). Database 1081 may store supply chain characteristics, product taxonomy, location taxonomy, event times, event locations and promotional data linked by reference to specific supply chain point-in-time events. Master Database 1084 is an enterprise database designed to collect, cleanse, harmonize, aggregate and publish granular event data from many points of distribution and retailers. An example of a master database system is Vision Chain's Data Signal Repository™ (DSR). Master database 1084 may store product categories, product subcategories, segments, finelines, product characteristics, product tags and historical event data. In an embodiment, master database 1084 may optional with all data being stored in database 1081. Memory 1085 is in communication with the processor 1082. Memory 1085 stores processing instructions for directing processor 1085 to accept user-input defining a scenario comprising one or more implicit events in the supply chain, accept user-input defining a filter, associate the filter with the scenario, receive explicit event data, filter the explicit event data using the user defined filter and correlate filtered explicit event data with the scenario to determine or predict occurrence of one or more implicit events in the scenario.

In an embodiment, memory 1085 stores processing instructions for directing processor 1085 to accept user-input defining a scenario that has an out-of-stock event. The out-of-stock event definition includes a p-level, a baseline time period and a test time period. For example, the user may use the interface illustrated in FIG. 11 to define the out-of-stock event. Memory 1085 also stores processing instructions for directing processor 1085 to receive explicit event data including point-of sale data, calculate a first variance in point-of-sale data during the baseline time period, calculate a second variance in point-of-sale data during the test time period, calculate a difference between the first and second variances, compare the difference to the p-level and indicate an out-of-stock event if the difference is greater than the p-level. In an embodiment, Memory 1085 also stores processing instructions for directing processor 1085 to store supply chain characteristics, accept user-input defining a filter, associate the filter with the scenario and filter explicit event data using the filter.

The present invention, or portions thereof, can be implemented in hardware, firmware, software, and/or combinations thereof.

FIG. 11 illustrates an interface to enter information to define criteria for measuring the variances in absolute values of inventory in the supply chain. This is an example of application metadata that a user might create as a criterion to use solely or in combination with other metadata. In this example, the user wants to find out if the current five day selling period has a product out-of-stock. The user would select the product in question and the store as well in their process of creating a filter. In an embodiment, the scenario selection of a criterion is resolved into the WHERE clause of structured query language. In the first step, the user names the criterion which ultimately will be represented quantitatively in one or more of the structures in FIG. 6. In section 2 a user selects a measure on which to base the criterion. In this case the user selects point-of-sale quantity (‘quantity’). Alternatively, a user may create a new measure by combining pre-existing measures in the database. The second part of step 2 is to define the number of days in the baseline period and the test period. In the third step, a user either defines an absolute difference between the test and baseline periods or select a statistical test and significance level. Finally in step 4 a user may select if other users are allowed to view and ostensibly use their criterion in other scenarios. By using an interface such as in FIG. 11, a user would be able to define a wide range of scenarios where the variance in data represents some change at the store. In an embodiment, the interface in FIG. 11 enables a user to identify durations with a lack of explicit events which could also be defined as a criterion identifying a supply chain implicit event.

To resolve issues with absolute total inventory figures, embodiments presented herein, measure changes or variances in measured values rather than absolute value of measurements. In this approach, the absolute value is not used. What is relied on is the superior consistency of the ability of any system to track changes to potentially correct or incorrect measured absolute values.

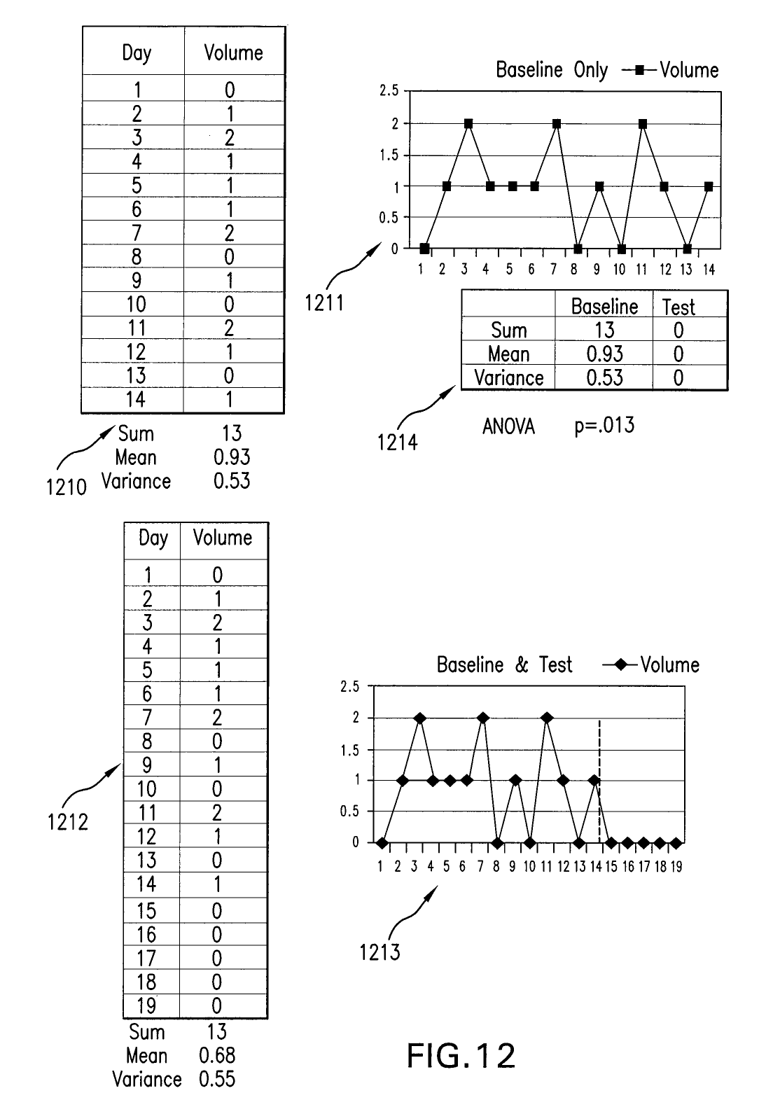

FIG. 12 illustrates sample sales quantity data. In this figure, one can see the sales quantity during the baseline and test period, as well as key statistical measures. Imagine a product in a specific store over a period of a few weeks. To understand the variability in how often customers purchase the product, one can view tabular data showing the quantity sold on the first day, then the next day, and onward (1210). Many products in grocery stores, for example, will sell zero, one, or two items per day—the figures in 1210 match this reality. The graphical view in 1211 shows a typical pulsing in demand offset by days of no sales that are based not on the fact there are no products on the shelf, but rather the normal ups and downs of demand for items that only sell a very low quantity each day. In order to differentiate these normal zero-quantity days with an ‘out-of-stock’ event, one must measure the variability in demand from the ‘normal’ period—a baseline—and apply it to the current period to see if there is a statistically significant difference. The period in 1210 and 1211 are the baseline. However, on day 14 the single item sold represents the last one sold. For the next five days the sales quantity is zero (1212). In 1213 one can see the dashed line is the point at which the product went out of stock. The current invention takes the variance in the baseline, which is 0.53 in display 1210 and 1214, and compares it to the variance of the test period—those current five days—which is 0 shown in display 1214. In embodiments a statistical test is performed which is a one-way analysis of variance designed to find out if the two variances are significantly different. A threshold is set, in this case, using a significance test where a result that occurs by chance only once in twenty is deemed to be significant, i.e. p<0.05, the variances of the baseline and test periods are significantly different. This tells the user that there is an out-of-stock in the current period. One advantage of this approach is that it would work even if the internal measurement systems erroneously state that the sales quantity or on hand quantity is 1, 2, or some other non-zero number as a result of an error in the absolute value. The variance method resolves errors in methods that rely on either the absolute measure or on fixing that absolute measure as part of their method.

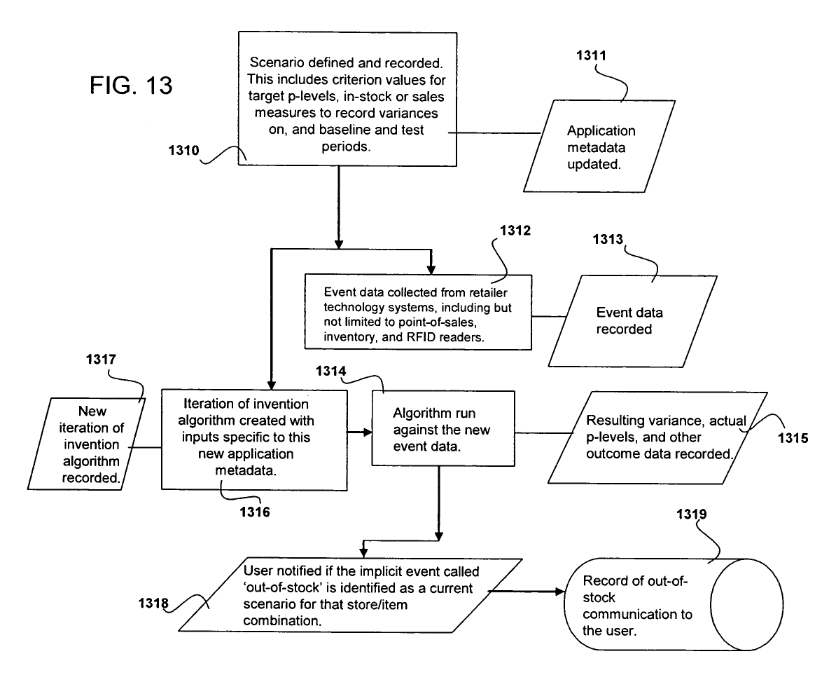

FIG. 13 is a flowchart illustrating steps to identify out-of-stock events according to an embodiment of the invention.

In step 1310, the scenario is defined as shown in step 521 of FIG. 5, using interfaces in FIG. 8 and FIG. 11, data from which is recorded textually and quantitatively in tables such as in FIG. 6.

In step 1311 values defined in the scenario from step 1310 are saved in the tables illustrated in FIG. 6.

In step 1312, explicit event data is collected and recorded in step 1313, such as is shown in its broader context in FIG. 5, step 513.

In step 1316, as the explicit event data is being collected, statistical tests are run against quantitative data selected in step 1310. This includes a computer implemented routine to run statistical tests for the measures defined in step 1310 using the event data from step 1312, specifically the subset of 1312 event data fields identified in step 1310.

In step 1317 the iteration in step 1316 is recorded in object code form. In an alternate embodiment, the algorithm recorded in step 1317 may include durations of no event data being returned for certain fields (i.e. a different set of implicit event criteria having been selected in step 1310 and recorded in step 1317).

In step 1314 the event data from step 1312 is statistically analyzed as described above to find out if there is significant variance between the baseline and test periods.

In step 1315, the results from step 1314 are recorded.

In step 1318, the user is notified of the results from step 1314.

In step 1319, a record is created in step 1319 which shows the user was notified on a specific date of an out-of-stock.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method to identify implicit events in a supply chain, comprising:
storing supply chain characteristics;
accepting user-input defining a scenario comprising one or more implicit events in the supply chain;
accepting user-input defining a filter;
associating the filter with the scenario;
receiving explicit event data;
filtering the explicit event data using the user defined filter; and
correlating filtered explicit event data with the scenario to determine or predict occurrence of one or more implicit events in the scenario.

2. The method of claim 1, wherein a scenario defines anticipated flow of a product in the supply chain.

3. The method of claim 1, wherein a filter limits the scenario to specific products, locations and event times.

4. The method of claim 1, further comprising linking one or more products and locations to explicit event data.

5. The method of claim 1, further comprising loading location links to explicit event data.

6. The method of claim 1, wherein the supply chain characteristics are one or more of product taxonomy, location taxonomy, historical event data and historical metadata.

7. The method of claim 6, wherein product taxonomy comprises one or more of product categories, product subcategories, segments, finelines, product characteristics and product tag.

8. The method of claim 7, wherein a product tag is one or more of a Serialized Global Trade Identification Number (sGTIN), barcode, RuBee radio tag and Serial Shipping Container Code (SSCC).

9. The method of claim 1, further comprising correlating explicit event data with historical metadata.

10. The method of claim 1, further comprising enabling a user to modify the scenario or define a second scenario.

11. The method of claim 1, further comprising enabling the user to edit the filter or define a second filter.

12. The method of claim 1, further comprising displaying the implicit event if the correlation of explicit event data and the scenario indicates the occurrence of an implicit event.

13. The method of claim 1, wherein the correlating step further comprises displaying a list of implicit events that match the implicit events defined in the scenario.

14. The method of claim 13, further comprising enabling a user to delete, highlight, sort and/or select the list of implicit events.

15. The method of claim 14, further comprising enabling a user to view characteristics of a selected implicit event.

16. A system to identify implicit events in a supply chain, comprising:
a processor;
a database for storing supply chain characteristics, product taxonomy, location taxonomy, event times, event locations and promotional data linked by reference to specific supply chain point-in-time events;
a memory in communication with the processor, the memory for storing a plurality of processing instructions for directing the processor to:
accept user-input defining a scenario comprising one or more implicit events in the supply chain;
accept user-input defining a filter;
associate the filter with the scenario;
receive explicit event data;
filter the explicit event data using the user defined filter; and
correlate filtered explicit event data with the scenario to determine or predict occurrence of one or more implicit events in the scenario.

17. The system of claim 16, further comprising a master database coupled to the database via a network, wherein the master database stores one or more of one or more of product categories, product subcategories, segments, finelines, product characteristics, product tags and historical event data.

18. The system of claim 16, wherein specific point-in-time events comprise Serialized Global Trade Identification Number (sGTIN) tag reads.

19. A method for identifying an out-of-stock event in a supply chain, comprising:
accepting user-input defining a scenario comprising the out-of-stock event, wherein the out-of-stock event includes a p-level, a baseline time period and a test time period;
receiving explicit event data including point-of sale data;
calculating a first variance in point-of-sale data during the baseline time period;
calculating a second variance in point-of-sale data during the test time period;
calculating a difference between the first and second variances;
comparing the difference to the p-level; and
indicating an out-of-stock event if the difference is greater than the p-level.

20. The method of claim 19, further comprising:
storing supply chain characteristics;
accepting user-input defining a filter;
associating the filter with the scenario; and
filtering explicit event data using the filter.
